(19) United States
(12) Patent Application Publication
(10) Pub. No.: US 2011/0264932 A1
(43) Pub. Date: Oct. 27, 2011

(54) HOME APPLIANCE AND METHOD OF OPERATING THE SAME

(76) Inventors: Noma PARK, Changwon-Si (KR); Manho Chun, Changwon-Si (KR); Taekyu Ha, Changwon-Si (KR); Jinhee Noh, Changwon-Si (KR); Hwanjong Choi, Changwon-Si (KR); Heewoong Park, Changwon-Si (KR)

(21) Appl. No.: 13/090,630

(22) Filed: Apr. 20, 2011

(30) Foreign Application Priority Data
Apr. 21, 2010 (KR) 10-2010-0037091

(51) Int. Cl. G06F 1/32

(52) U.S. Cl. 713/310

(57) ABSTRACT

A home appliance and a method of operating the same are provided. By controlling operation of the home appliance with varied rate information according to a power consumption amount, an entire power consumption amount is reduced, and by preventing power consumption from being concentrated in a specific time zone, power consumption is distributed.

### CROSS-REFERENCE TO RELATED APPLICATION

This application claims the benefit of Korean Application No. 10-2010-0037091, filed on Apr. 21, 2010 in the Korean Intellectual Property Office, the disclosure of which is incorporated herein by reference.

### BACKGROUND

1. Field

This relates to a home appliance and a method of operating the same, and more particularly, to a home appliance and a method of operating the same that can vary operation according to rate information in a smart grid system.

2. Background

Nowadays, many devices are used for making convenient a human being's living. At home, user convenience is provided using an air conditioner for indoor air, a refrigerator for storing food, a television and radio for providing entertainment, and a computer, and in a factory, for manpower shortage, dangerous work processing, and quick work processing, most operations are performed by a machine.

Various appliances including home appliances use electricity as an energy source, and a power plant for generating electrical energy has been built.

Nowadays, energy consumption gradually increases and existing fossil fuel has been exhausted, and thus an interest in new energy development increases and an interest in saving of energy consumption also increases.

In a summer season in which energy consumption increases, a predetermined amount of energy is generated to meet with a demand of electrical energy, but as energy consumption gradually increases, a problem occurs in energy supply and demand. However, in a present situation where a power plant cannot unlimitedly increase, a research for a method of reducing energy consumption has been performed.

Accordingly, a demand system is applied to measure a power amount consumed in a building and to prevent a maximum power consumption amount from exceeding a predetermined value, or by controlling an operation factor of operating appliances, power consumption is limited and managed, but these methods do not correspond to increase of energy consumption.

Thereby, instead of simply limiting and managing energy consumed at a home or a building, a method of generating energy according to a required power amount by organically connecting an energy consumption side and an energy generation side like a power plant through a communication network and of changing energy consumption according to increase or decrease of the generated energy and the consumed energy is suggested.

Thereby, while reducing and managing entire energy consumption, by minimizing waste of unnecessarily consumed energy, effective energy generation and energy consumption can be performed.

### SUMMARY

Embodiments as broadly described herein may solve the above problems, and may provide a home appliance and a method of operating the same that can efficiently consume energy by varying operation of the home appliance according to received rate information.

According to an embodiment as broadly described herein, there is provided a home appliance including: a communication unit for receiving rate information changed according to a power use amount by communicating with a smart server; an input unit for inputting an operation mode and operation setting according to the operation mode; an output unit for outputting an operation state and the rate information; and a controller for changing and operating the operation setting according to the rate information of one of an off peak, a partial peak, and a peak and for controlling the output unit to output the operation state.

According to another embodiment as broadly described herein, there is provided a method of operating a home appliance, the method including: inputting an operation mode and operation setting of the operation mode; receiving rate information changed according to a power use amount from a smart server connected to a wired or wireless network; and changing the operation setting according to the rate information of one of an off peak, a partial peak, and a peak and operating the home appliance.

### BRIEF DESCRIPTION OF THE DRAWINGS

Embodiments set forth herein will become more fully understood from the detailed description given herein below and the accompanying drawings, which are given by illustration only, and thus are not limiting, and wherein:

FIG. 1 is a diagram illustrating a configuration of a smart grid system according to an exemplary embodiment;

FIG. 2 is a diagram illustrating a configuration of home appliances and a smart server in the smart grid system of FIG. 1;

FIG. 3 is a block diagram illustrating a configuration of a home appliance in the smart grid system of FIG. 1;

FIG. 4 is a flowchart illustrating a method of changing operation according to rate information in the home appliance of FIG. 3;

FIG. 5 is a flowchart illustrating a method of changing operation according to a receiving state of rate information in the home appliance of FIG. 3;

FIG. 6 is a flowchart illustrating a method of changing operation according to predetermined rate information in the home appliance of FIG. 3;

FIG. 7 is a graph illustrating an example of a consumption change of energy supplied to home appliances and a change of rate information according to the consumption change of energy;

FIG. 8 is a table and graph illustrating an example of an operation record of home appliances according to rate information;

FIG. 9 is a table illustrating an example of an energy consumption change in the method of FIG. 4; and

FIG. 10 is a graph illustrating an example of rate information varying according to an energy consumption change.

### DETAILED DESCRIPTION

Hereinafter, exemplary embodiments will be described in detail with reference to the accompanying drawings.

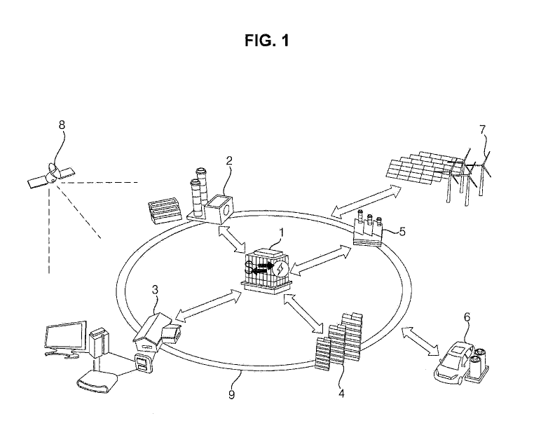

FIG. 1 is a diagram illustrating a configuration of a smart grid system according to an exemplary embodiment of the present invention.

As shown in FIG. 1, the smart grid system includes power generation systems 5 and 7 for generating energy, an energy consumption side, for example, a factory 2, a home 3, a company, a building 4, a vehicle charging station 6, a network 9 for connecting such an energy generation side and energy consumption side, and a power management server 1 for organically connecting the energy generation side and the energy consumption side using the network.

The power generation system, which is an energy generation side is not limited to a thermal power plant 5, a wind force, sun light, or solar heat power plant 7, a nuclear power plant, and a hydropower plant and includes all power generation systems for generating energy.

The energy consumption side includes a plurality of home appliances provided within a home, a mechanical equipment and an air conditioning appliance of a factory, an elevator, an escalator, a lighting device, a ventilation device, an air conditioning appliance of a building, and a vehicle charging station. Other appliances using electrical energy are included in an energy consumption side.

The network includes a wired network of a local area network (LAN), a power line network, and a phone network, a wireless network such as a wireless LAN, Wibro, a mobile communication network, and high-speed downlink packet access (HSDPA), and a communication network using a satellite 8. In this case, it is unnecessary to unify a network for connecting each element as one network, and an energy consumption side and an energy generation side can be connected through a link between previously installed different communication networks. The network may further include a device for connecting different communication networks.

The smart grid system connects an energy generation side and an energy consumption side separated from each other through a communication network, and thus a power generation system for generating energy can estimate and change an energy generation amount according to an energy consumption pattern, and the energy consumption side grasps a generated energy amount, an entire energy consumption pattern, and changes operation.

In this case, the power management server generates rate information changing according to energy generation of a power generation system, an energy consumption situation and a power use amount of each energy consumption side, and transmits the generated rate information to each energy consumption side.

Each energy consumption side includes each smart server, receives rate information from the power management server 1, and transmits the received rate information to each appliance. Accordingly, each appliance variably controls operation according to rate information. The smart server collects power consumption information of a plurality of appliances and transmits the power consumption information to the power management server 1.

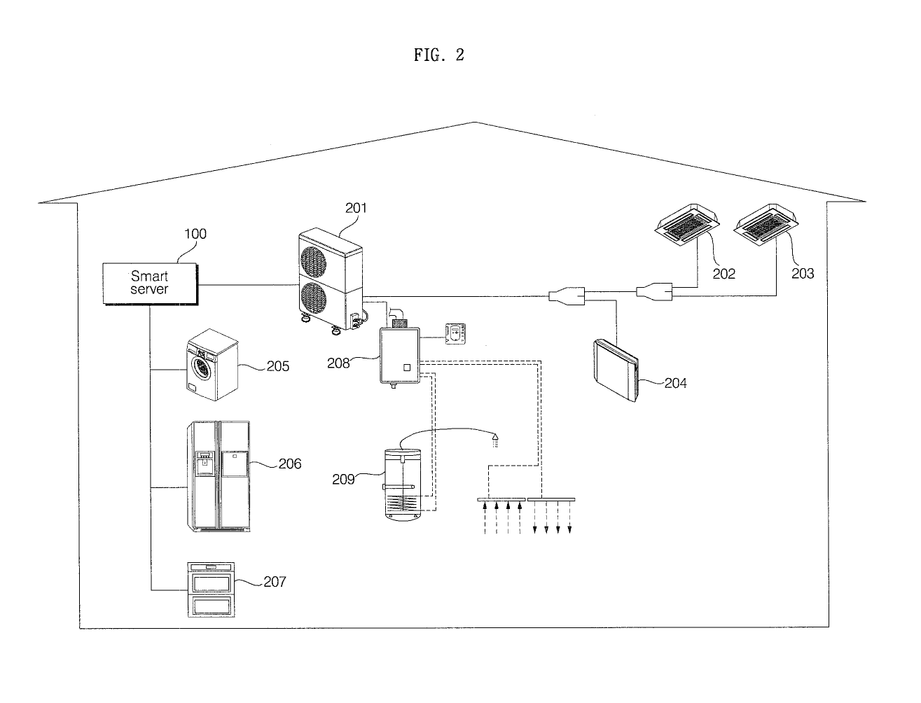

FIG. 2 is a diagram illustrating a configuration of a home appliance and a smart server in the smart grid system of FIG. 1.

As shown in FIG. 2, the home 3 of the energy consumption side includes a plurality of home appliances 201 to 209, and a smart server 100.

The home appliance includes a washing machine 205, a refrigerator 206, a Kimchi refrigerator 207, an outdoor unit 201, indoor units 202 to 204, a ventilation device, and heaters 208 and 209. Further, the home appliance may further include appliances that consume energy such as an electric oven, an electric rice cooker, an iron, and a lighting device.

In this case, the air conditioner includes a plurality of units of indoor units 202 to 204 for discharging cold air to indoor and an outdoor unit 201 connected to the indoor units and may include a local controller connected to the indoor units and for inputting an operation instruction to the indoor units or a remote controller connected to a plurality of units and for controlling and monitoring the operation. The air conditioner may be operated by interlocking with a ventilation unit.

Further, the air conditioner according to an exemplary embodiment may be classified into a system air conditioner, a stand type air conditioner, or a wall-mounted air conditioner, may have different configurations and disposition according to a kind thereof, and may be applied regardless of a form thereof.

In this case, a plurality of home appliances are connected to a predetermined network to be each connected to the smart server 100. The plurality of home appliances are integrated and connected through a network and may be separated by different networks, but are connected to the smart server 100 according to each communication method.

The smart server 100 may be provided on a building basis or on a furniture basis, and in a large-scale building or factory, a plurality of smart servers may be provided. When a plurality of smart servers are provided, each smart server is connected to a network, and a smart server may be set as a master.

The smart server 100 is connected to the power management server 1 of the smart grid system to transmit and receive information about a consumption power amount, receives rate information from the power management server 1, and transmits the rate information to a plurality of connected home appliances. The smart server 100 periodically communicates with the power management server 1 and immediately transmits the changed rate information to the home appliance.

The smart server 100 separately accumulates and stores an operation time period of each home appliance according to a segment value of each rate information based on the received rate information and calculates power consumption information and estimated electric rates. Further, the smart server 100 transmits information about power consumption of a plurality of home appliances to the power management server 1.

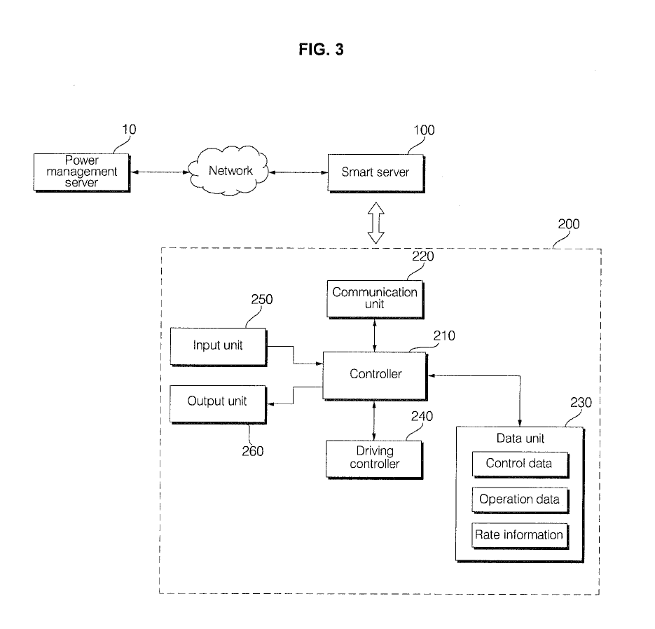

FIG. 3 is a block diagram illustrating a configuration of a home appliance in the smart grid system of FIG. 1.

As shown in FIG. 3, an exemplary home appliance 200 includes a communication unit 220, an input unit 250, an output unit 260, a driving controller 240, a data unit 230, and a controller 210 for controlling entire operations of the home appliance.

Each home appliance generally includes the above-described element and may be differently formed according to a characteristic of each appliance. For example, an outdoor unit includes a compressor, an outdoor unit fan, etc., and an indoor unit includes an indoor unit fan, a wind regulator, etc. The home appliance exemplifies an air conditioner including an outdoor unit and an indoor unit, and a description of other configurations of the home appliance will be omitted.

The communication unit 220 includes at least one communication module and transmits and receives data to and from other units of an outdoor unit or an indoor unit, communicates with the smart server 100, receives rate information from the smart server 100, and transmits operation information about operation of the air conditioner to the smart server 100.

In this case, the communication unit 220 may use different communication methods for communication between the outdoor unit or the indoor unit and communication with the smart server 100 and selectively uses a communication module according to a communication method with a target to communicate. The communication unit 220 may include a converter for transmitting data of different communication methods.

The input unit 250 includes an input means such as at least one switch, button, touch pad, and a dial and is used for inputting data such as an operation mode of operation and power supply for operating an air conditioner, operation setting according to the operation mode, and a schedule.

The output unit 260 includes at least one output means of a display light such as a lamp and a light emitting diode (LED), a display unit, and a speaker and outputs an operating state of an air conditioner. In this case, as an operating state of the air conditioner, a present operation state, input setting, and a normal operation is displayed with characters, numerals, and special characters and is output by effect sound or warning sound, and an operation light or a warning light.

Further, the output unit 260 displays rate information received through the communication unit 220, displays operation information of an air conditioner corresponding to specific rate information, and rate information thereof according to a control instruction of the controller 210. In this case, rate information is calculated by the controller 210 or calculated in the smart server 100 and is received through the communication unit 220.

In the indoor units 202 to 204, the output unit 260 outputs information of a present operating state, and indoor temperature as well as setting information such as a setting temperature, a setting air flow, and an operation mode that are input through the input unit 250, and outputs at least one of warning sound, a warning light, and a warning message when abnormality occurs.

In this case, the input unit 250 and the output unit 260 are provided in a lower surface, a lower part, and an upper part of a front portion and a front panel of the indoor units 202 to 204, and a position thereof is not limited to a position of this description.

In the data unit 230, setting data about operation of an air conditioner and control data for an operation control are stored, and data received from other units of an outdoor unit or another indoor unit are stored, and operation record is stored as operation data. Further, rate information received from the smart server 100 is stored in the data unit 230.

The driving controller 240 performs a predetermined operation according to setting of the input unit 250 by a control instruction of the controller 210. For example, in the indoor unit, the driving controller 240 performs entire operations such as driving of an indoor unit fan, opening and closing of a valve, or angle adjustment of a louver or a vane. In the outdoor unit, the driving controller 240 performs entire operations such as driving of a compressor, driving of an outdoor unit fan, and opening and closing of a valve.

The driving controller 240 supplies refrigerant from the outdoor unit to the input unit through such an operation and controls the indoor unit to discharge cold air in which a heat is exchanged.

The controller 210 generates a control instruction to operate an air conditioner according to data that are input through the input unit 250 and controls transmission and reception of data through the communication unit 220 and data input/output of the data unit 230. Further, the controller 210 applies a control instruction to the driving controller 240 according to setting and thus controls the air conditioner to operate according to setting.

Further, the controller 210 changes input operation setting according to rate information received from the smart server 100 through the communication unit 220 and thus variably controls operation of the air conditioner.

Particularly, the controller 210 changes operation setting according to whether a present rate segment corresponds to which one of an off peak, a partial peak, and a peak according to a value of rate information, and controls the output unit 260 to output an operation state thereof.

Further, while operating, when new rate information is received from the smart server 100 through the communication unit 220, the controller 210 determines whether the new rate information is different from previously received rate information, and if rate information is changed, the controller 210 resets operation setting according to the changed rate information and changes operation of the air conditioner.

The controller 210 changes operation setting of one of a target temperature, an operation factor, and an operation area according to rate information. Particularly, the controller 210 changes operation setting by changing a target temperature of one of a heating mode, a cooling mode, and a hot water supply mode.

When the air conditioner operates in a heating mode in a peak, the controller 210 lowers a heating target temperature, raises a cooling target temperature in a cooling mode, and lowers a hot water supply target temperature in a hot water supply mode, thereby controlling the air conditioner to perform a power saving operation. Further, the controller 210 changes operation setting to an average value between input operation setting and minimum operation in a partial peak.

That is, the controller 210 controls the air conditioner to operate to the minimum in a peak and to operate according to input setting, i.e., according to a user's request in an off peak.

The controller 210 operates the air conditioner so that a user does not feel unpleasant while performing power saving operation further than input operation setting using a comfortable temperature range in a peak and a partial peak. The comfortable temperature range represents a difference in an uncomfortable feeling and a comfortable feeling according to a season and an operation mode.

When rate information is in a peak, the controller 210 changes operation setting to a minimum value of a comfortable temperature range according to an operation mode and performs power saving operation. When rate information is in a partial peak, the controller 210 operates the air conditioner by changing operation setting to an average value of a minimum value of a comfortable temperature range according to an operation mode and operation setting that is input through the input unit 250, and when rate information is in an off peak, the controller 210 operates the air conditioner according to operation setting that is input through the input unit 250.

Further, when the peak is sustained for a predetermined time period or more, i.e., when a power saving operation is sustained for a predetermined time period or more, even if operation setting is changed in consideration of a comfortable temperature range, a user may feel an unpleasant feeling and thus the controller 210 stops operation and sets a reminder to resume operation after a predetermined time period.

When operation setting is changed, the controller 210 controls the output unit 260 to display information about the changed operation setting and may control to display rate information together with the information about the changed operation setting.

When the controller 210 does not perform an operation control according to rate information by setting, the controller 210 controls operation of the air conditioner according to the input operation setting regardless of the rate information. Operation according to rate information is set through the input unit 250.

Further, when the communication unit 220 erroneously operates or when rate information is not received for a predetermined time period or more from the smart server, because operation cannot be performed according to rate information, the controller 210 controls to operate the air conditioner according to operation setting that is input through the input unit 250.

The controller 210 separately counts and records an operation time period according to rate information, and when operation is terminated, the controller 210 controls the data unit 230 to record data about a change of rate information and a change of operation setting according to the rate information change. In this case, the controller 210 individually counts an operation time period of each of an off peak, a partial peak, and a peak.

The controller 210 periodically transmits the stored data to the smart server 100 or transmits the stored data when operation is terminated, as described above.

The smart server 100 receives data about an operation record according to rate information, and an operation time period from a plurality of home appliances and calculates rate calculation data that receive from the power management server 1, a power amount consumed by a plurality of home appliances, and electric rates corresponding to the consumed power amount based on a preset rate schedule. The smart server 100 individually calculates estimated electric rates of each of a plurality of home appliances and transmits the calculated estimated electric rates to each home appliance.

In some case, the home appliance may calculate estimated electric rates based on an operation time period on a rate information basis. The controller 210 receives a rate schedule according to rate information from the smart server and calculates estimated electric rates using a reference rate of each of an off peak, a partial peak, and a peak calculated according to a total power consumption amount and an operation time period on a rate segment basis.

The controller 210 controls the output unit 260 to display rate information calculated by the smart server 100 or the home appliance.

Operation of a home appliance according to an exemplary embodiment having the above-described configuration will be described with reference to the drawings.

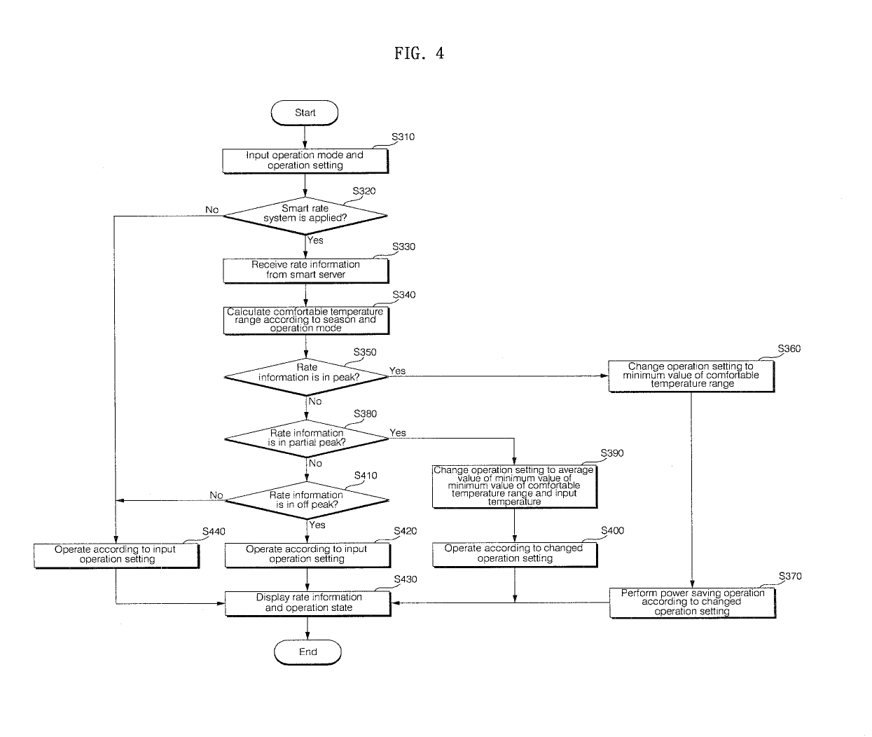

FIG. 4 is a flowchart illustrating a method of changing operation according to rate information in the home appliance of FIG. 3.

Referring to FIG. 4, when an operation mode and operation setting according to the operation mode are input through the input unit 250 (S310), the controller 210 determines whether a smart rate system for changing operation setting according to rate information received from the smart server 100 is applied (S320).

If a smart rate system is not applied, the controller 210 disregards rate information received from the smart server 100 and operates the home appliance according to the input operation setting (S440).

If a smart rate system is applied, the controller 210 receives rate information from the smart server 100 through the communication unit 220 (S330).

In this case, rate information received from the smart server 100 is data about a rate segment according to a present total power consumption amount and is a value differently applied according to a power consumption amount or a power demand to a power supply in the power management server 1, and divides a change point of a reference rate for calculating electric rates as a segment.

Rate information is divided into three rate segments, i.e., a peak, a partial peak, and an off peak, and a value thereof is set. The peak is a most expensive rate segment, and the off peak is a least expensive rate segment. The peak is a segment having a much power use amount, the partial peak is a segment in which a power use amount partially increases, and the off peak is a segment having a less power use amount.

Such rate information may be divided into two levels, or subdivided as segments of rate information into four levels and five levels, and a reference of dividing a segment may be changed, but in an exemplary embodiment, rate information is divided into three segments according to a power use amount. In this case, even in the same peak, a reference rate may be differently applied according to an accumulated power consumption amount.

The smart server 100 periodically receives rate information from the power management server 1 and transmits the received rate information to a plurality of connected home appliances, and the home appliances each receives rate information from the smart server 100, as described above.

The controller 210 calculates a comfortable temperature range according to season information of an operating time point and a set operation mode (S340). In this case, a comfortable temperature range is a temperature range in which a user feels comfortable using a season, relative humidity, and a wet bulb temperature and follows McQuiston & Parker's reference. For example, when performing a heating operation in a winter season, a comfortable temperature range is set to about 19° C. to 23° C., and when performing a cooling operation in a summer season, a comfortable temperature range is set to about 21° C. to 27° C. and can be changed according to humidity.

The controller 210 determines whether the received rate information is in a peak (S350), and if the received rate information is in a peak, the controller 210 changes operation setting to a minimum value of a comfortable temperature range (S360).

The controller 210 performs a power saving operation according to the changed operation setting (S370).

In this case, a minimum value is a value of minimally consuming energy for performing a power saving operation, and when an air conditioner performs a heating operation, a minimum value is a minimum temperature within a comfortable temperature range, and when an air conditioner performs a cooling operation, a minimum temperature is a maximum value within a comfortable temperature range. For example, when a heating operation is performed, a target temperature is set to 19° C. in a range of 19° C. to 23° C., and when a cooling operation is performed, a target temperature is set to 27° C. in a range of 21° C. to 27° C. and operation setting is changed.

If the received rate information is not in a peak at step S350, the controller 210 determines whether rate information is in a partial peak (S380), and if the rate information is in a partial peak, the controller 210 changes operation setting to an average value of a minimum value of a comfortable temperature range and a temperature value of the input operation setting (S390) and operates the air conditioner according to the changed operation setting (S400).

For example, when the input operation setting is a wishing temperature 22° C. in a cooling operation, an average temperature 24.5° C. of a maximum temperature 27° C., which is a minimum value of a comfortable temperature and the wishing temperature 22° C. in a cooling operation is set as a target temperature and thus operation setting is changed. When the input operation setting is a wishing temperature 25° C. in a heating operation, an average temperature 22° C. of the wishing temperature 25° C. and a minimum value 19° C. of a comfortable temperature is set as a target temperature.

If the controller does not determine that rate information is in a partial peak at step S380, the controller 210 determines whether the rate information is in an off peak (S410), and if the rate information is in an off peak, the controller 210 operates the air conditioner according to the input operation setting without a separate operation setting change (S420). The off peak is a cheapest rate segment and thus the air conditioner is operated according to a user's wish.

If the rate information is not in an off peak, i.e., when rate information is not received or when information about the rate segment is not included in rate information, the controller 210 determines that abnormality exists in the rate information and ignores the rate information and operates the air conditioner according to the input operation setting (S440).

The controller 210 controls the output unit 260 to display rate information and an operation state of the air conditioner while operating (S430).

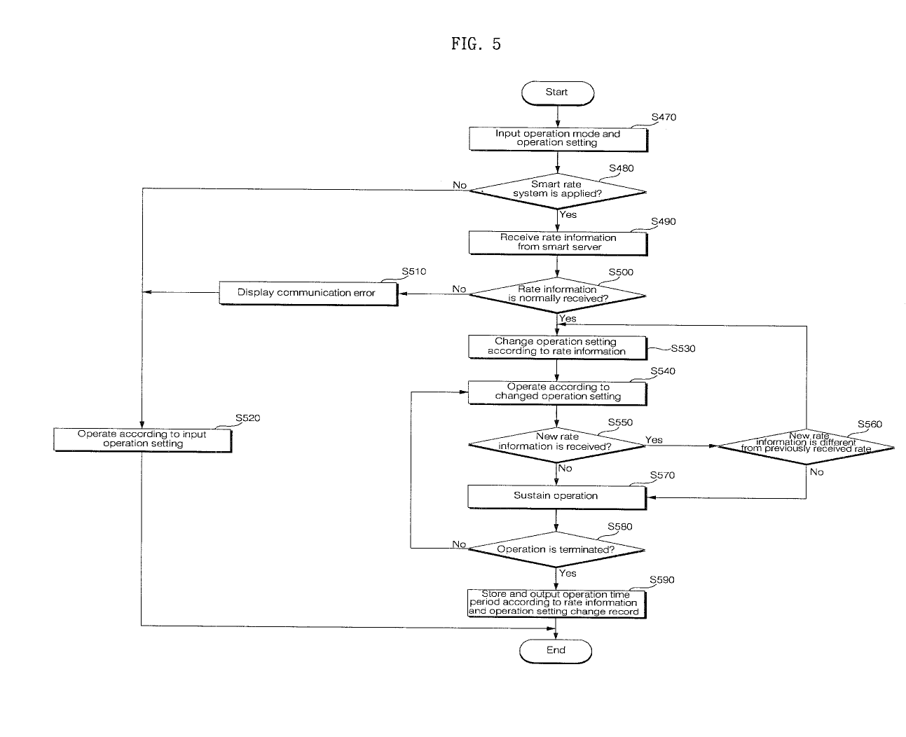

FIG. 5 is a flowchart illustrating a method of changing operation according to a receiving state of rate information in the home appliance of FIG. 3.

Referring to FIG. 5, an operation mode and operation setting are input (S470), and the controller 210 determines whether a smart rate system for an operation control according to rate information of the smart server 100 is applied (S480).

If a smart rate system is not applied, the controller 210 operates the air conditioner according to the input operation setting (S520).

If a smart rate system is applied, the controller 210 receives rate information from the smart server 100 through the communication unit 220 (S490), and the controller 210 determines whether the received rate information is normally received (S500).

In this case, if the received rate information is not normally received or if the received rate information has an error, the controller 210 determines this as a communication error and controls the output unit 260 to display a communication error (S510) and operates the air conditioner according to the input operation setting regardless of rate information (S520).

If rate information is normally received, the controller 210 changes operation setting according to rate information (S530). As shown in FIG. 4, the controller 210 changes operation setting according to one of a peak, a partial peak, an off peak changed according to a power use amount.

The controller 210 operates the air conditioner according to operation setting that is set by rate information (S540).

In this case, the communication unit 220 may receive rate information by periodically connecting to the smart server 100 and receive rate information by connecting to the smart server 100 when an event occurs.

The controller 210 determines whether new rate information is received through the communication unit 220 (S550). If new rate information is received through the communication unit 220, the controller 210 determines whether the new rate information is different from previously received rate information (S560). If the new rate information is different from previously received rate information, the process returns to step S530 and thus the controller 210 changes operation setting according to the changed rate information (S530) and operates the air conditioner according to the operation setting (S540).

If the new rate information is not different from previously received rate information, the controller 210 sustains operation of the air conditioner (S570).

The controller 210 determines whether operation of the air conditioner is terminated (S580), and if operation of the air conditioner is not terminated, the process returns to step S540 and thus the controller 210 operates the air conditioner according to the operation setting.

If operation of the air conditioner is terminated, the controller 210 controls the data unit 230 to store a record about changed rate information while operating, an operation time period according to the changed rate information, and change contents, and the output unit 260 to output the record about the changed rate information while operating, the operation time period according to the rate information, and change contents (S590).

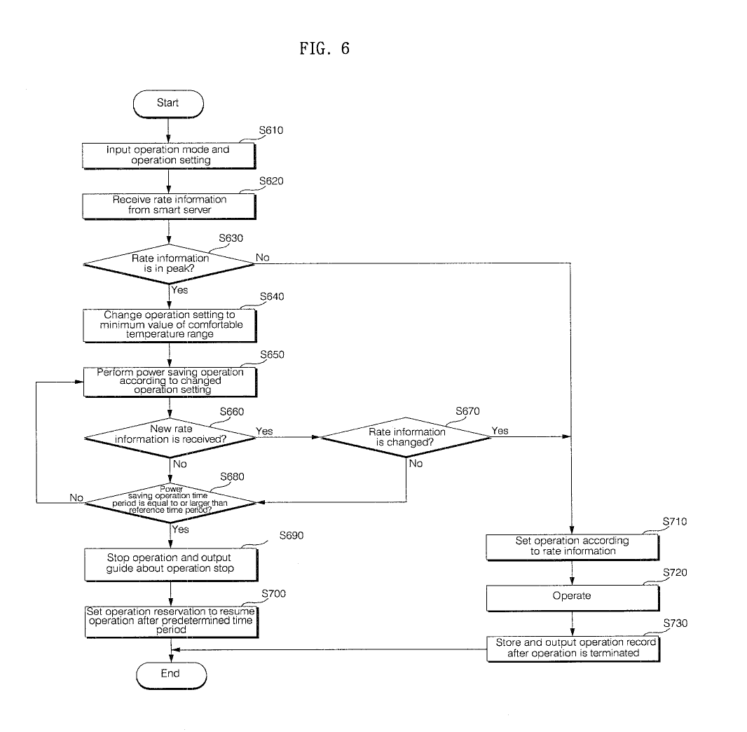

FIG. 6 is a flowchart illustrating a method of changing operation according to predetermined rate information in the home appliance of FIG. 3.

Referring to FIG. 6, in the air conditioner, an operation mode and operation setting are input (S610), and the controller 210 receives rate information from the smart server (S620). As shown in FIG. 4, the controller 210 changes operation setting according to the received rate information or operates the air conditioner according to the input operation setting.

The controller 210 determines whether rate information is in a peak (S630). If rate information is not in a peak, the controller 210 sets operation of the air conditioner according to the rate information (S710) and operates the air conditioner (S720).

If rate information is in a peak, the controller 210 changes operation setting to a minimum value of a comfortable temperature range (S640).

The controller 210 performs a power saving operation according to the changed operation setting (S650). In this case, the controller 210 counts a power saving operation time period.

As shown in FIG. 5, while operating the air conditioner, the controller 210 determines whether new rate information is received through the communication unit 220 (S660), and if new rate information is received through the communication unit 220, the controller 210 determines whether rate information is changed (S670), and if rate information is not changed or if new rate information is not received through the communication unit 220 at step S660, the controller 210 sustains operation of the air conditioner and determines whether a counted power saving operation time period is equal to or larger than a reference time period (S680).

If a counted power saving operation time period is less than a reference time period, the process returns to step S650 and thus the controller 210 performs a power saving operation according to the changed operation setting. If rate information is changed at step S670, the controller 210 sets operation of the air conditioner according to the changed rate information (S710) and operates the air conditioner (S720). When a power saving operation is terminated due to a change of rate information and a general operation is performed, the controller 210 initializes a power saving operation time period.

If a counted power saving operation time period is equal to or larger than a reference time period at step S680, the controller 210 stops operation of the air conditioner according to setting and controls the output unit 260 to display a guide about an operation stop (S690). The controller 210 sets an operation reservation to resume operation after a predetermined time period (S700). The controller 210 controls to store and output an operation record after operation is terminated (S730).

Therefore, a home appliance cannot be operated for a long time period in a peak of expensive rates and can be operated in other segments of cheap rates. Here, a reference time period of a power saving operation can be changed according to setting and may be operated without a limitation of a separate power saving operation time period.

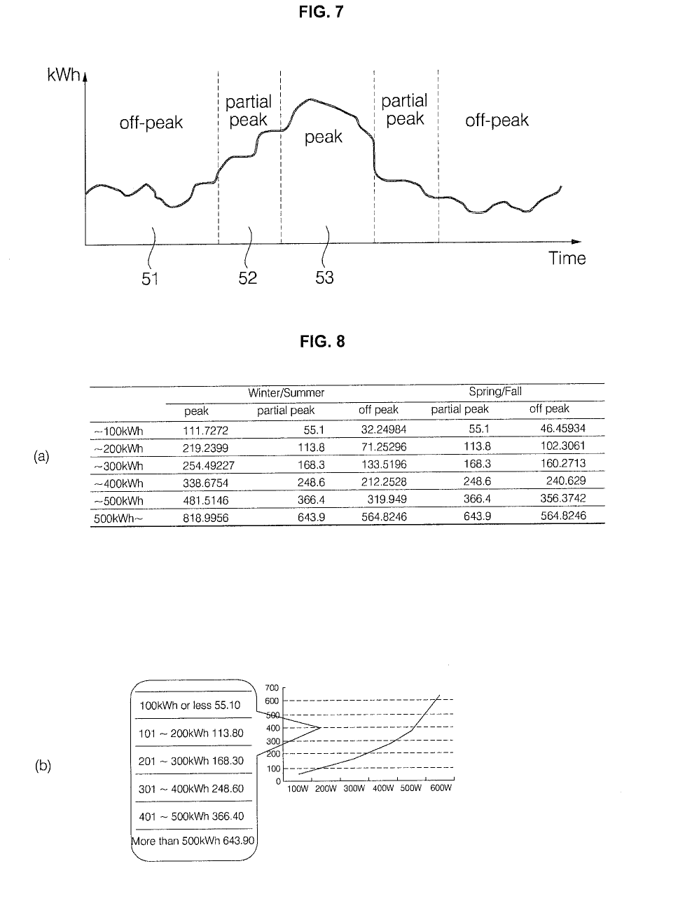

FIG. 7 is a graph illustrating an example of a consumption change of energy supplied to a home appliance and a change of rate information according to the energy consumption change.

As shown in FIG. 7, the power management server 1 varies rates according to data about a collected power consumption amount and generates rate information thereof.

In this case, when a power consumption amount is a predetermined value or more, or is sustained to a predetermined value or more for a predetermined period, the power management server 1 changes and sets a rate segment. The power management server 1 generates rate information on a predetermined time period basis, and the predetermined time period can be changed in a unit of a time or a day.

The power management server 1 divides a rate segment into three segments and generates rate information. When a power consumption amount is less than a first reference value, if a power consumption amount is sustained for a predetermined time period with a value of less than a first reference value, the power management server 1 sets an off peak 51 with a cheap rate.

Further, when a power consumption amount is a second reference value or more, if a power consumption amount is sustained for a predetermined time period with a second reference value or more, a power consumption amount is a maximum, and thus the power management server 1 sets a peak 53 with a most expensive rate.

When a power consumption amount is a first reference value or more and less than a second reference value, or even if a power consumption amount intermittently exceeds the second reference value, when a power consumption amount is reduced to a value of less than the second reference value, the power management server 1 sets the segment as a partial peak 52.

As described above, when a power use amount is much, a rate is expensively set, and when a power use amount is less, a rate is cheaply set and thus rate information is generated, whereby an energy consumption side can determine whether to use power according to rate information.

Accordingly, the energy consumption side saves energy and a power generation system, which is an energy generation side may not excessively generate energy and can thus reduce energy waste.

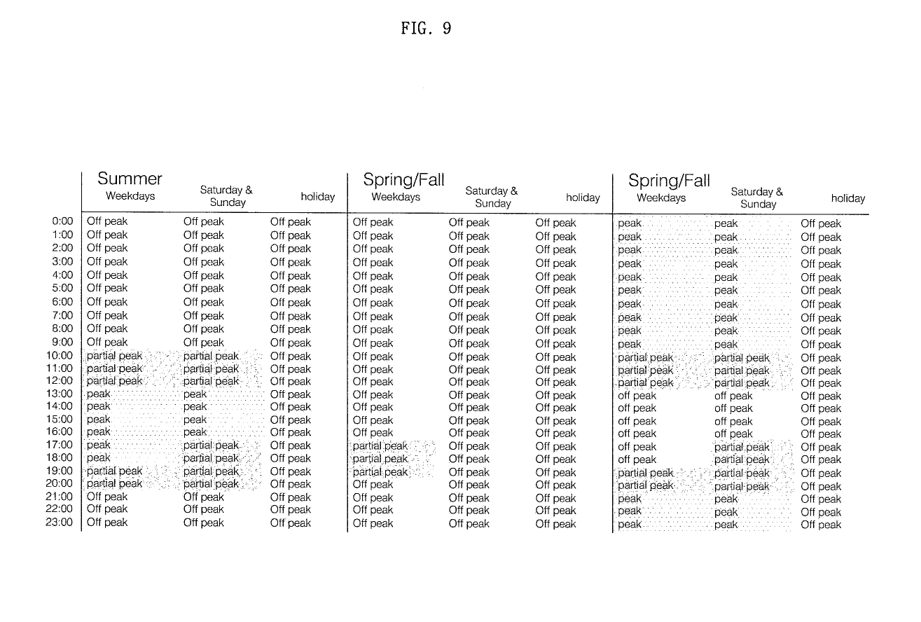

FIG. 8 is a table and graph illustrating an example of rate information varying according to an energy consumption change, and FIG. 9 is a table illustrating an example of an operation record of a home appliance according to rate information.

As shown in FIG. 8, electric rates are changed on a season basis, on rate information basis, and according to an accumulated use amount. As an accumulated use amount increases for a predetermined period, an expensive rate is applied, and a rate changes on a rate segment basis according to rate information.

The controller 210 separately counts an operation time period on a rate segment basis according to rate information and stores the operation time period, as shown in FIG. 9. In this case, the controller 210 transmits an operation record including an operation time period according to rate information to the smart server 100.

The controller 210 calculates rate information for a predetermined period using the rate information and an operation record of the home appliance.

Further, the smart server 100 calculates estimated electric rates of a plurality of home appliances and individual estimated electric rates of each home appliance using the rate schedule and the operation record. When estimated electric rates are calculated in the smart server 100, each home appliance receives and displays calculated estimated electric rates from the smart server 100 instead of separately calculating estimated electric rates.

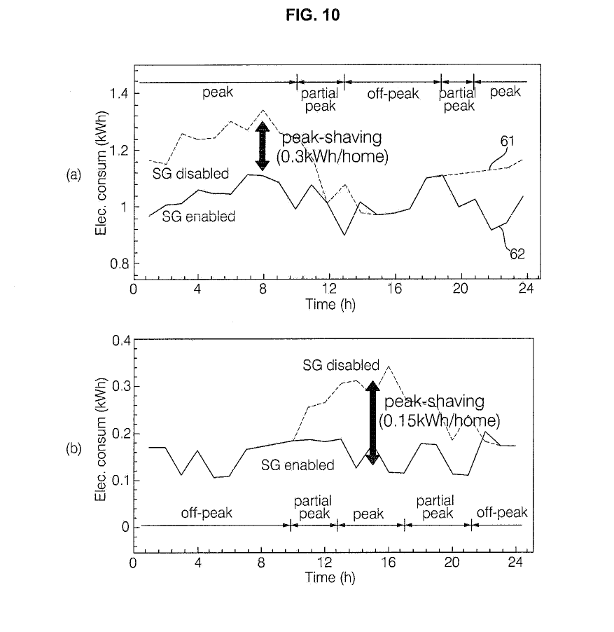

FIG. 10 is a graph illustrating an example of an energy consumption change in the method of FIG. 4.

As described above, by applying a smart rate system for generating rate information so as to change a rate according to a power use amount and for controlling operation of appliances according to rate information in each energy consumption side, energy consumption can be changed, as shown in FIG. 8.

FIG. 8(a) is a graph illustrating a power consumption change of a winter season, and FIG. 8(b) is a graph illustrating a power consumption change of a summer season.

Because a power generation system generates power based on a maximum power consumption amount, as a difference between a maximum power consumption amount and a minimum power consumption amount increases, waste energy increases.

As shown in FIGS. 10(a) and 10(b), when a smart rate system is applied, power use is prevented from being concentrated in a specific time zone. In a peak, power consumption is reduced and thus a peak is reduced. By applying a smart rate system, power consumption in an existing peak is reduced by 0.15 kWh/home to 0.3 KWh/home.

Therefore, according to the present invention, entire energy consumption is reduced and energy consumption is prevented from being concentrated in a specific time zone, and thus energy waste is minimized, whereby effective energy generation and energy consumption can be performed.

In a home appliance and a method of operating the same according to the present invention having the above-described configuration, by changing operation of the home appliance according to a change of rate information, operation of the home appliance is minimized in a peak and the home appliance operates in an off peak, and thus electric rates can be managed so that electric rates according to operation of the home appliance are not excessively generated, and energy consumption in the home appliance can be effectively improved. Further, by reducing energy consumption in a time zone having a much energy consumption amount, energy consumption can be managed and controlled.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A home appliance, comprising:
a communication device that communicates with a smart server to receive rate information that changes based on power usage levels, the rate information corresponding to operation at one of an off peak, a partial peak or a peak level;
an input that receives an operation mode input and operation setting input corresponding to the operation mode input;
an output device that outputs an operation state of the home appliance and the rate information received from the smart server; and
a controller that changes the input operation setting based on the rate information received from the smart server, that controls operation of the home appliance based on the changed operation setting, and that controls the output device to output the operation state of the home appliance and the rate information.

2. The home appliance of claim 1, wherein the controller changes a current operation setting to a minimum value of a comfortable temperature range of a current operation mode and performs a power saving operation when the rate information received from the smart server corresponds to operation at the peak level.

3. The home appliance of claim 2, wherein the controller changes the current operation setting to an average minimum value of a comfortable temperature range corresponding to the input operation mode and corresponding input operation and operates the home appliance when the rate information received from the smart server corresponds to operation at the partial peak level.

4. The home appliance of claim 3, wherein the controller operates the home appliance at the input operation setting when the rate information received from the smart server corresponds to operation at the off peak.

5. The home appliance of claim 2, wherein the controller stops operation of the home appliance after a predetermined operation time has elapsed and sets a reminder to resume operation of the home appliance after a predetermined off time has elapsed.

6. The home appliance of claim 1, wherein the communication device periodically receives updated rate information from the smart server during operation of the home appliance, and the controller resets the operation setting and operates the home appliance at the reset operation setting when the updated rate information is different from the previous rate information.

7. The home appliance of claim 6, wherein the home appliance is an air conditioning apparatus that provides heating and cooling, and wherein the controller changes a target temperature of one of a heating mode, a cooling mode, or a hot water supply mode to reset the operation setting, and operates the air conditioning apparatus.

8. The home appliance of claim 1, wherein the controller changes one of a target temperature, an operation factor, or an operation area to change the operation setting and operate the home appliance.

9. The home appliance of claim 1, wherein the controller operates the home appliance in accordance with the input operation setting when rate information is not received from the smart server or when operation of the home appliance cannot be performed within parameters of the received rate information.

10. The home appliance of claim 1, wherein, upon termination of operation of the home appliance, the controller records data related to changes of the operation setting based on the rate information, calculates operation time periods at each of the off peak, partial peak, and peak levels, and controls the communication device to transmit the calculated operation time periods to the smart server.

11. The home appliance of claim 10, wherein the controller receives a reference rate of the off peak, the partial peak, and the peak operation that is calculated based on a total power consumption amount and a preset rate schedule, and receives an rate calculated based on actual operation times at the off peak, partial peak and peak levels from the smart server, and controls the output device to output the reference rate and the actual rate.

12. A method of operating a home appliance, the method comprising:
receiving an operation mode input and operation setting input corresponding to the operation mode input;
receiving rate information from a smart server connected to a wired or wireless network, the rate information corresponding to power usage levels including one of an off peak, a partial peak or a peak level; and
changing the input operation setting based on the received rate information and operating the home appliance at the changed operation setting.

13. The method of claim 12, further comprising:
receiving new rate information from the smart server while operating the home appliance; and
resetting the operation setting and operating the home appliance at the reset operation setting when the new rate information is different from the previously received rate information.

14. The method of claim 12, wherein operating the home appliance comprises:
changing the operation setting to a minimum value of a comfortable temperature range corresponding to the input operation mode and performing a power saving operation when the rate information received from the smart server corresponds to the peak level.

15. The method of claim 14, further comprising:
suspending operation of the home appliance after peak operation of the home appliance is sustained for a predetermined operation time or more;
setting a reminder to resume operation of the home appliance after a predetermined suspension time has elapsed; and
resuming operation of the home appliance.

16. The method of claim 12, wherein operating the home appliance comprises:
changing the operation setting to an average minimum value of a comfortable temperature range corresponding to the input operation mode and the input operation setting and operating the home appliance at the changed operation setting when the rate information received from the smart server corresponds to the partial peak level.

17. The method of claim 12, wherein operating the home appliance comprises operating the home appliance at the input operation setting when the rate information received from the smart server corresponds to the off peak level.

18. The method of claim 12, wherein the home appliance is an air conditioner, and wherein operating the home appliance comprises changing a target temperature of one of a heating mode, a cooling mode, or a hot water supply mode to reset the operation setting and operating the home appliance at the reset operation setting.

19. The method of claim 12, wherein operating the home appliance comprises changing the operation setting of one of a target temperature, an operation factor, or an operation area of the home appliance and operating the home appliance at the changed operation setting.

20. The method of claim 12, further comprising operating the home appliance at the input operation setting when rate information is not received from the smart server or when operation of the home appliance cannot be performed within parameters of the received rate information.

21. The method of claim 12, further comprising:
recording and outputting data related to changes in the operation setting corresponding to the rate information upon termination of operation of the home appliance; and
calculating an operation time period at each of the off peak, partial peak, and peak levels and transmitting the calculated operation time period to the smart server.

22. The method of claim 12, further comprising receiving a reference rate of at least one of the off peak, partial peak, or peak level calculated based on a total power consumption amount and a previously stored rate schedule, and a rate calculated in proportion to the operation time period based on the reference rate received from the smart server upon termination of the operation of the home appliance.
